(19) United States
(12) Patent Application Publication
(10) Pub. No.: US 2025/0299604 A1
(43) Pub. Date: Sep. 25, 2025

(54) PRODUCT SIGNAGE DISPLAY WITH STRUCTURE FOR ATTACHING TO A RETAIL STORE SHELF

(71) Applicant: Menasha Corporation, Neenah, WI (US)

(72) Inventors: Christopher R. Schroeder, Collegeville, PA (US); Lee Alucci, McAdoo, PA (US)

(21) Appl. No.: 19/084,301

(22) Filed: Mar. 19, 2025

Related U.S. Application Data
(60) Provisional application No. 63/568,894, filed on Mar. 22, 2024.

(51) Int. Cl. G09F 7/18

(52) U.S. Cl. CPC G09F 7/18; G09F 2007/1847; G09F 2007/1852

(57) ABSTRACT

The invention is directed to a product signage display with structure for attaching to a retail store shelf. The display can include a first graphic display panel rotate-ably connected to a second graphic display panel, a first arm extending from the first graphic display panel and a second arm extending from the second graphic display panel where the first arm and second arm are configured to receive a C-channel extending from the front edge of the retail store shelf. The first graphic display panel can include flaps and positioning panels for securing the display to the shelf. The positioning panel can position the flap to be inserted into a front pocket of the C-channel. The display can be formed from a paper material.

### CROSS-REFERENCE TO RELATED APPLICATIONS

The present invention claims priority to and the benefit of U.S. Provisional Patent Application No. 63/568,894 filed Mar. 22, 2024, the contents of which are incorporated herein by reference and made a part hereof.

### FEDERALLY SPONSORED RESEARCH OR DEVELOPMENT

N/A

### FIELD OF THE INVENTION

The present invention is generally directed to a sustainable display sign that can be easily connected to a retail store shelf, and more particularly, to a sign primarily formed a paper material having features to enable the sign to be secured to or around a C-channel extending from a front edge of a retail store shelf.

### DESCRIPTION OF THE PRIOR ART

Signs that extend outward from a retail store shelf can be used to draw attention to certain products on the shelf and/or to provide additional information relating to such products or other items in the store. The signs must be secured to the shelf in a manner that avoids or otherwise accommodates the C-channel typically attached to the front edge of the shelf. The C-channel is typically a flange-like structure that extends from the front edge of the retail store shelf at an angle and is typically used to provide pricing and other product information. A front pocket having an upper opening is provided in the C-channel for placement of such pricing or other information relating the products. The pocket can be a generally U-shaped structure having at least a front portion or wall formed from a translucent material, such as plastic.

Prior signs used were often made in three (or more) parts. These parts typically included a blade made of styrene or foam core plastic and metal, and hardware connecting the blade to the shelf, such as a post and bracket. The sign and hardware were expensive and difficult to secure to the retail store shelf.

The present invention provides signs that are easier to construct and connect to a shelf, and are less expensive to manufacture.

### SUMMARY OF THE INVENTION

The present invention is generally directed to a product signage display with structure for attaching the display to a retail store shelf. The structure of the display is specifically designed to accommodate a C-channel on the store shelf. The C-channel extends outward from the edge of the shelf—typically at an angle—and includes pricing and other information related to goods or products stocked on the shelf. The display is primarily formed from paperboard, making it cheaper and easier to manufacture than prior shelf signage systems.

In accordance with one aspect of the invention, a signage display for attaching to a retail store shelf comprises a first graphic display panel having a first arm portion extending outward on a first side of the first graphic display panel. The first arm potion is configured to receive a C-channel extending from an edge of a shelf and extend under the C-channel. A first positioning panel is rotate-ably connected to the first graphic display panel on the first side and is spaced above the arm portion. A first flap extends below the first positioning panel for engaging a slot in the C-channel to secure the first graphic display panel to the shelf. The slot is part of a pocket formed for receiving the pricing or other information.

The first positioning panel can be rotate-ably connected to the first graphic display panel by a fold line. Similarly, the first flap can be connected to the first positioning panel by a fold line.

The display can also include a second graphic display panel connected to the first graphic display panel by a fold line along a second side of the first graphic display panel. The second graphic display panel can include a second arm portion extending outward from a first side of the second graphic display portion. A second flap can be rotate-ably connected to a top edge of the second arm portion, preferably by a fold line. A side extension flap can be rotate-ably connected to a first side of the second flap, again preferably by a fold line. A second positioning panel can be rotate-ably connected to and extend outward from a first side of the second graphic display portion.

The display can be formed from a paper material, such as paperboard, or a corrugated paper or plastic sheet, or some other similar or suitable material. The display can then be formed as an blank of the material where components are connected by fold lines in the blank.

In accordance with another aspect of the invention, a signage display for attaching to a retail store shelf comprises a first graphic display panel having a first arm portion extending outward on a first side of the first graphic display panel. The first arm potion is configured to receive a C-channel extending from an edge of a shelf and to extend under the C-channel. The display further includes a first magnetic flap rotate-ably connected to a top edge of the first arm portion for contacting a lower surface of the shelf. The magnetic flap will adhere to a metal shelf or a shelf having a metal plate. The first magnetic flap can be rotate-ably connected to the top edge of the first arm portion by a fold line

A magnet in the form of a magnetic strip can be connected to the first magnetic flap. Other magnet types or shapes can also be utilized. The magnet can be glued or otherwise secured to the flap.

The display can further include a first stabilizing panel rotate-ably connected to an inner vertical edge of the first arm portion. The first stabilizing panel can be rotate-ably connected to an inner vertical edge of the first arm portion by a fold line.

The display can include a second graphic display panel having a second arm portion extending outward on a first side of the second graphic display panel. The second graphic display panel can be rotate-ably connected to the first graphic display panel by a fold line. A second magnetic flap can be rotate-ably connected to a top edge of the second arm portion by a fold line. A second stabilizing panel can also be rotate-ably connected to an inner vertical edge of the second arm portion by a fold line.

The display graphic display panels, flaps and stabilizing panels can be formed from a paper material, such as paperboard, or other similar or suitable material. The magnets can be secured to the flaps.

In another aspect of the present invention, a product signage display is provided that includes a first graphic display panel and a display holder having a first clip portion for connecting the holder to the C-channel of retail store shelf and a second clip portion for securing the first graphic display panel. The display can also include a second graphic display panel rotate-ably connected to the first graphic display panel by a fold line. The graphic display panels can be formed from a paper material, such as paperboard, or other similar or suitable materials. The holder can be formed from plastic or other similar or suitable materials.

In another aspect of the invention, a product signage display is provided that includes a first graphic display panel having a first elongated positioning panel rotate-ably connected to a first side of the first graphic display panel, and a first elongated flap rotate-ably connected to a bottom edge of the first positioning panel and configured to be inserted into a C-channel of a retail store shelf. The display can include a second graphic display panel rotate-ably connected to the first graphic display panel. A second positioning panel can be rotate-ably connected to a first side of the second graphic display panel and a second flap can be rotate-ably connected to a lower edge of the second positioning panel and configured to be inserted into the C-channel of the shelf. The display can be formed from paper, such as paperboard, or other similar or suitable materials.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1A is a perspective view three part blade sign for use on a retail store shelf in accordance with prior designs;

FIG. 1B is a side view of the sign of FIG. 1A illustrating the components of the sign without the shelf;

FIG. 2 is a perspective view of a slide in style sign secured to a retail store shelf in accordance with a first aspect of the present invention;

FIG. 3 is a perspective view of a magnetic sign secured to a retail store shelf in accordance with a second aspect of the present invention;

FIG. 4 is a series of signs in accordance with an aspect of the present invention;

FIG. 5 is a plan view of a blank for forming a slide in style sign in accordance with the present invention;

FIG. 6 is a plan view of another blank for forming a slide in style sign in accordance with the present invention;

FIG. 7 illustrates securing the slide in style sign onto a retail store shelf;

FIG. 8 is a plan view of a blank for forming a magnetic sign in accordance with the present invention:

FIG. 9 is a plan view of another blank for forming a magnetic sign in accordance with the present invention;

FIG. 10 illustrates securing the magnetic sign to a retail store shelf;

FIG. 11 is a perspective view of magnets that can be incorporated into the magnetic sign;

FIG. 12 is a plan view of a blank for a sign portion of a flag sign in accordance with yet another aspect of the present invention;

FIG. 13 is a perspective view of a clip for use with the flag sign;

FIG. 14 is a partial perspective view of the clip holding the sign portion;

FIG. 15 is a perspective view of a blade shelf strip sign in accordance with yet another aspect of the present invention; and,

FIG. 16 is a plan view of a blank for the blade shelf strip sign.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides several embodiments of a paperboard blade sign that connects to a retail shelf and/or to a C-channel on the shelf (i.e., the C-channel is an extension attached to and extending outward from the shelf at an angle that typically includes pricing information relating to products on the shelf). In some instances, magnets, such as flexible magnets with adhesive backings are attached to parts of the sign to facilitate securing it to the shelf. The paperboard blade signs are easily installed and do not require the expensive hardware of prior shelf signage. Additionally, the paperboard signs are more environmental friendly than prior signs that were formed from styrene, plastic and metal.

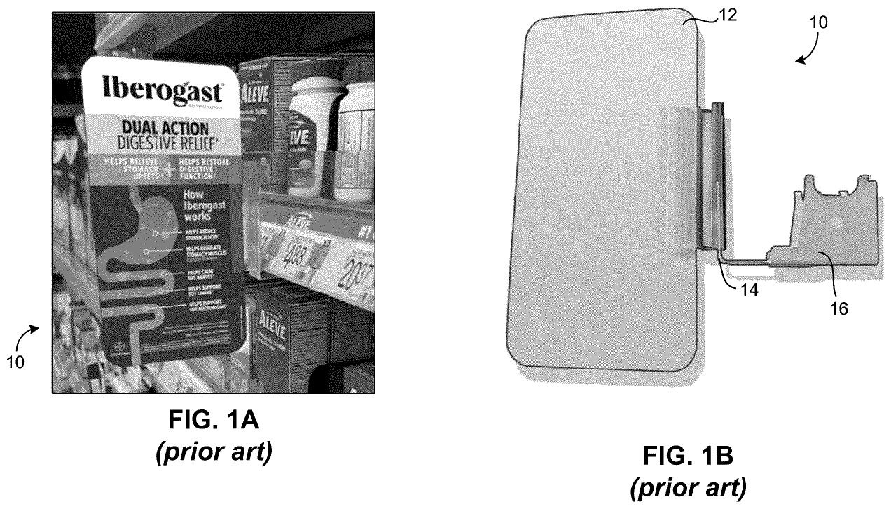

Prior signs used to mark sections of retail store shelves are typically expensive to manufacture and are difficult to install. One known sign 10 is shown in FIGS. 1A and 1B. This sign 10 included a graphic display panel 12 made from styrene or foam core plastic and metal. The panel 12 can be hung on a post 14 that was secured to the shelf by a bracket 16.

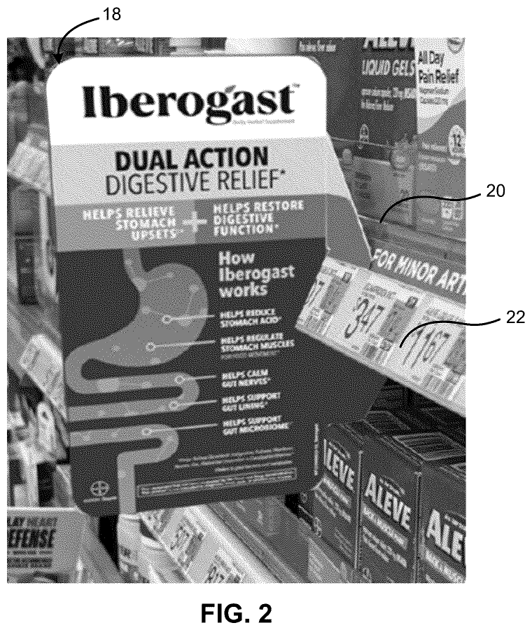

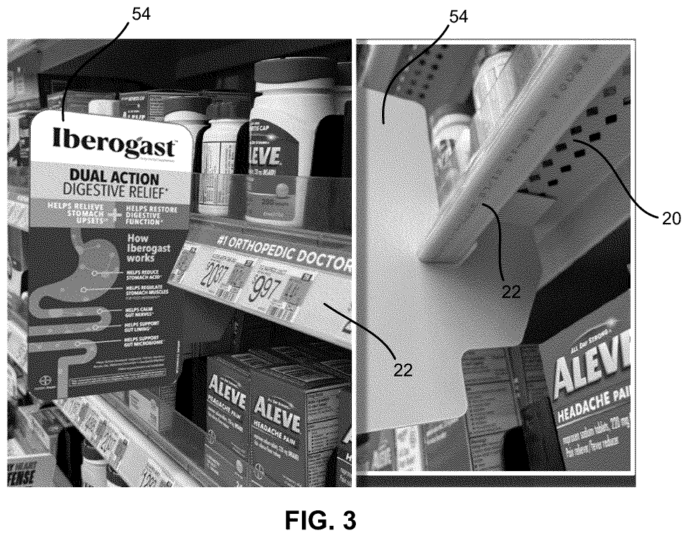

The present invention provides examples of a more sustainable display that is significantly less costly to manufacture and easier to install than the known designs shown in FIGS. 1A and 1B. In one aspect of the present invention, a slide in style display 18 is shown in FIG. 2. The display 18 is of one piece construction formed from paperboard or other similar material, and is easy to install on a typical retail store shelf 20 having a C-channel 22. The C-channel 22 extends outward at an angle from a front edge of the shelf and includes a pocket having an upper opening for placing price and other product related information (e.g., typically printed on paper) for items placed on the shelf.

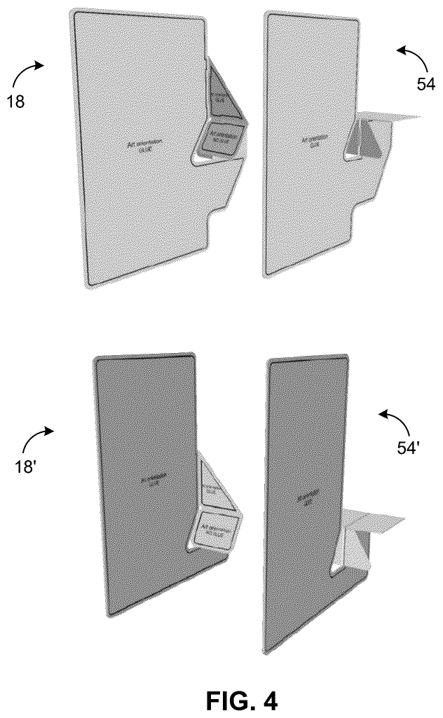

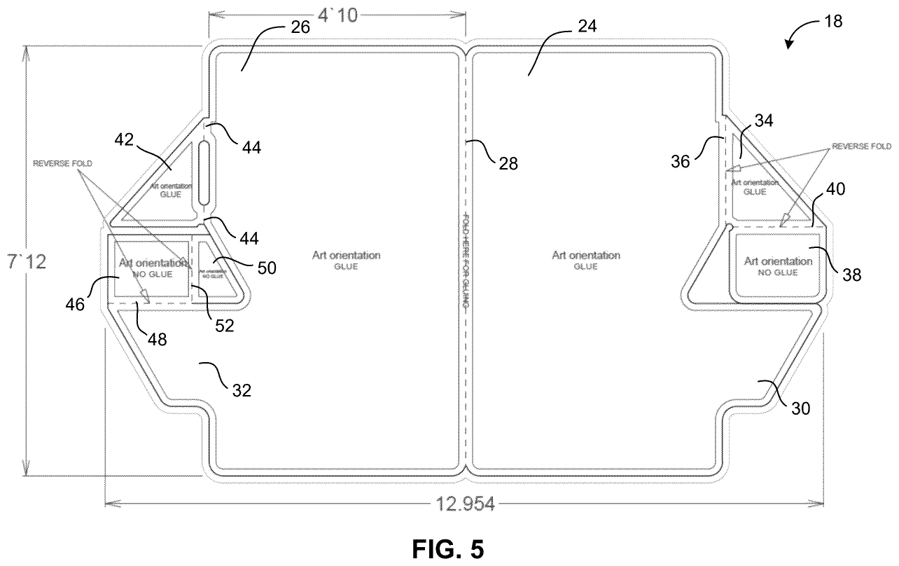

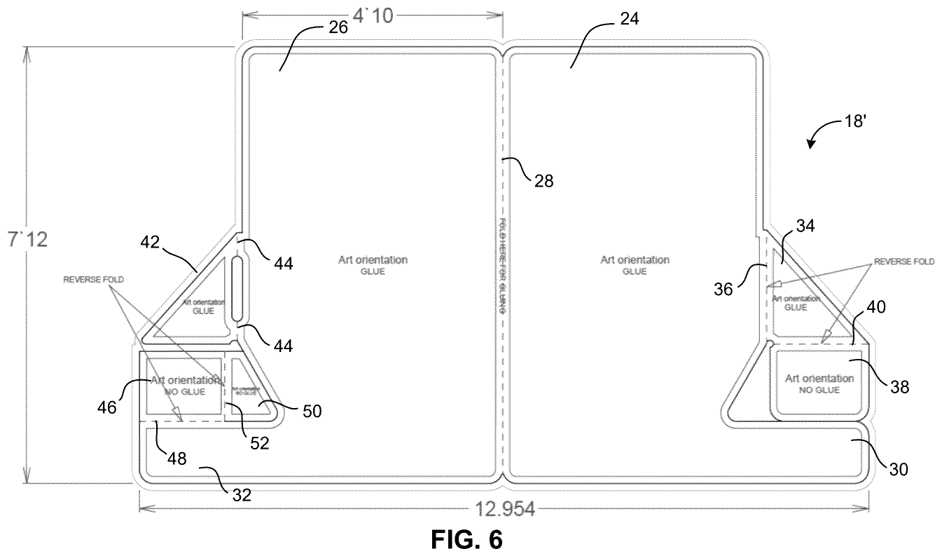

The display 18 includes foldable components to enable it to be secured to the shelf 20 via the C-channel 22 as described in more detail herein. The display 18, and an alternative display 18′ having slightly different dimensions, are shown in FIG. 4. Blanks for forming the displays 18, 18′ are illustrated in FIGS. 5 and 6 (respectively).

Referring to FIG. 5, the display 18 includes a first graphic display panel 24 connected to a second graphic display panel 26 by a fold line 28 that enables the second panel 26 to rotate about the fold line 28 with respect to the first panel 24. The first graphic display panel 24 includes a first arm portion 30 that extends outward from a first side of the panel 24. The second graphic display panel 26 includes a second arm portion 32 extending outward from a first side of the second graphic display panel 26. The first and second graphic display panels 24, 26, and the first and second arm portions 30, 32, mirror each other and make a single piece when folded together along the fold line 28. As shown in FIG. 2, the arm portions 30, 32 are positioned to extend under the C-channel 22 of the shelf 20.

The first graphic display panel 24 includes components to connect the display 18 to the shelf 20. One of these components is a positioning panel 34 that is connected to the first side of the first graphic display panel 24 by a fold line 36 (all of the fold lines in the embodiments described allow one component to be rotate-ably connected to another component). The positioning panel 34 is above the first arm portion 30, and includes a first flap 38 connected to a lower edge of the positioning panel 34 by a fold line 40.

The second graphic display panel 26 includes structure for connecting the two panels 24, 26 together and for contacting a back side of the C-channel 22 and lower surface of the shelf 20. The second graphic display panel 26 includes a second positioning panel 42 that extends outward from the first side of the second graphic display panel 26 and which mirrors the first positioning panel 34. The second positioning panel 42 is connected to the second graphic display panel 26 by a broken fold line 44. The second graphic display panel 26 also includes a second flap 46 connected to a top edge of the second arm 32 by a fold line 48. A side extension 50 is connected to the second flap 46 by a fold line 52.

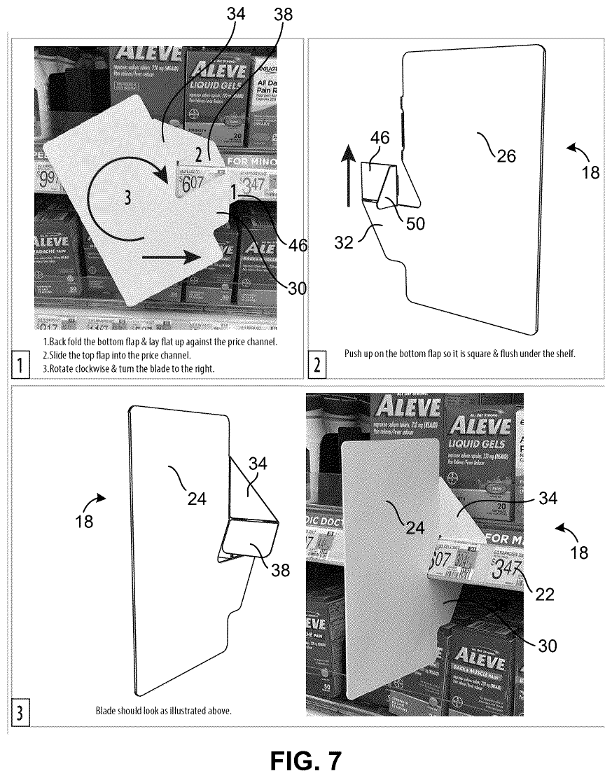

As illustrated in the series of steps shown in FIG. 7, to connect the display 18 to the shelf 20, the second graphic panel 26 is folded (or rotated) about the fold line 28 to align with the first graphic display panel 24 to form a backside of the display 18. The second flap 46 (and attached side extension 50) is then folded (or rotated) downward and the first positioning panel 34 (and attached first flap 38) and the second positioning panel 42 are collectively folded outward to the configuration shown in the top left portion of FIG. 7. The first flap 38 is then inserted (i.e., slid) into the pocket (i.e., price channel) and the display 18 is rotated to position the first and second arm portions 30, 32 under the C-channel 22. The second flap 48 is then rotated back upward (behind the C-channel 22) and the side extension 50 is folded away from the display panels 24, 26 to help prevent the display 18 from moving away from the C-channel 22. The arms 30, 32 and portions of the graphic display panels 24, 26 above the arms form a somewhat notched area configured to receive and conform to the angled shape of the C-channel 22.

The first and second graphic panels 24, 26 can include information, designs, advertisements etc. Since the first and second graphic panels are made from a single blank of material and are folded together, only one side of the blank needs to be printed. In this embodiment, the entire display 18 is formed from the blank which can be paperboard, corrugated paper or plastic, or other similar or suitable materials While the display 18 is shown having a first and a second graphic display panel 24, 26, a single graphic display panel can be used.

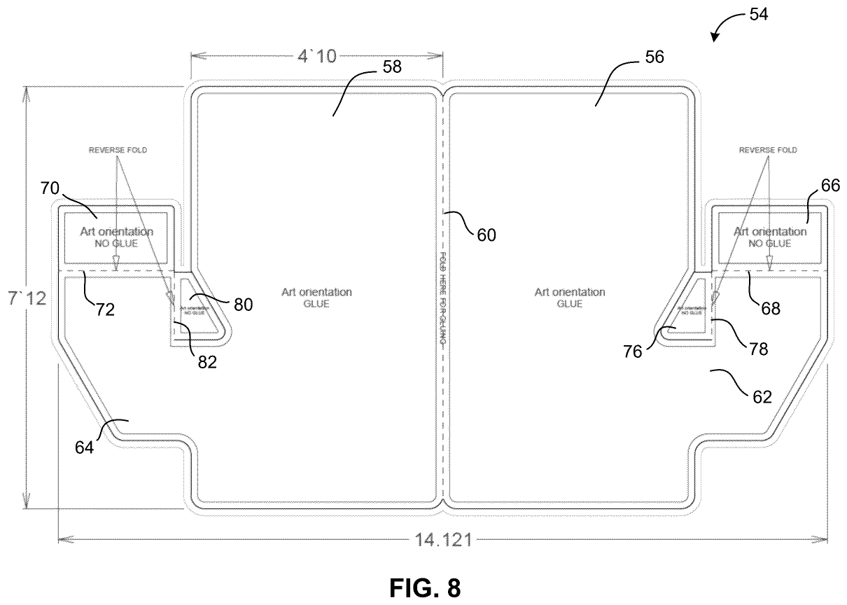

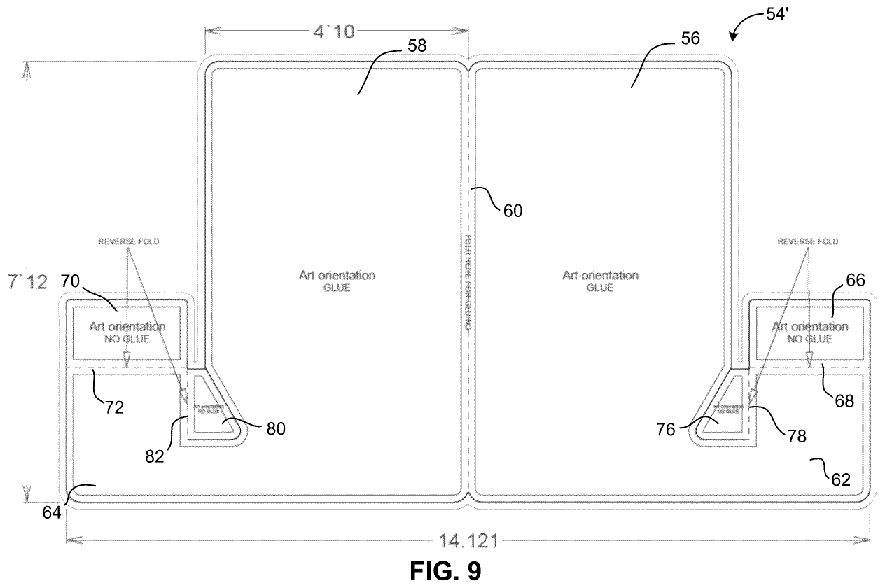

In another aspect of the invention, a display 54 having a magnetic connection to a retail store shelf 20 is shown. FIG. 4 discloses a perspective view—without the shelf 20 or C-channel 22—of a first magnetic display 54 and a second display 54′ having slightly different dimensions/features. Blanks for forming the magnetic displays 54, 54′ are shown in FIGS. 8 and 9 (respectively).

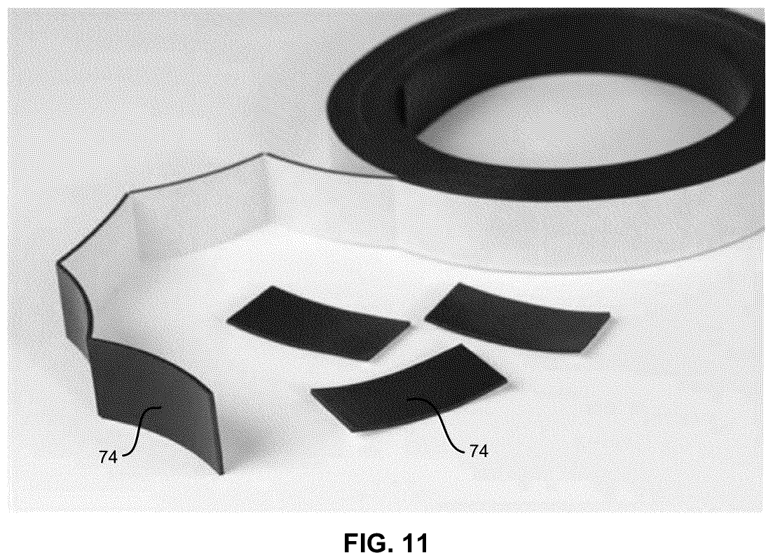

Similar to the slide in style, the magnetic display 54 (for use with metal shelves) includes a first graphic display panel 56 rotate-ably connected to a second graphic display panel 58 by a fold line 60. A first arm portion 62 extends outward from a first side of the first graphic display panel 56, and a second arm portion 64 extends outward from a first side of the second graphic display panel 58. A first magnetic flap 66 is rotate-ably connected to a top edge of the first arm portion 62 by a fold line 68, and a second magnetic flap 70 is rotate-ably connected to a top edge of the second arm portion 64 by a fold line 72. While not shown on the blank, a magnetic, such as a strip magnet 74 having an adhesive backing, as shown in FIG. 11, can be applied to the flaps 66, 70. A first stabilizing segment 76, is rotate-ably connected to a vertical inner edge of the first arm portion 62 by a fold line 78, and a second stabilizing segment 80 is rotate-ably connected to a vertical inner edge of the second arm portion 64 by a fold line 82.

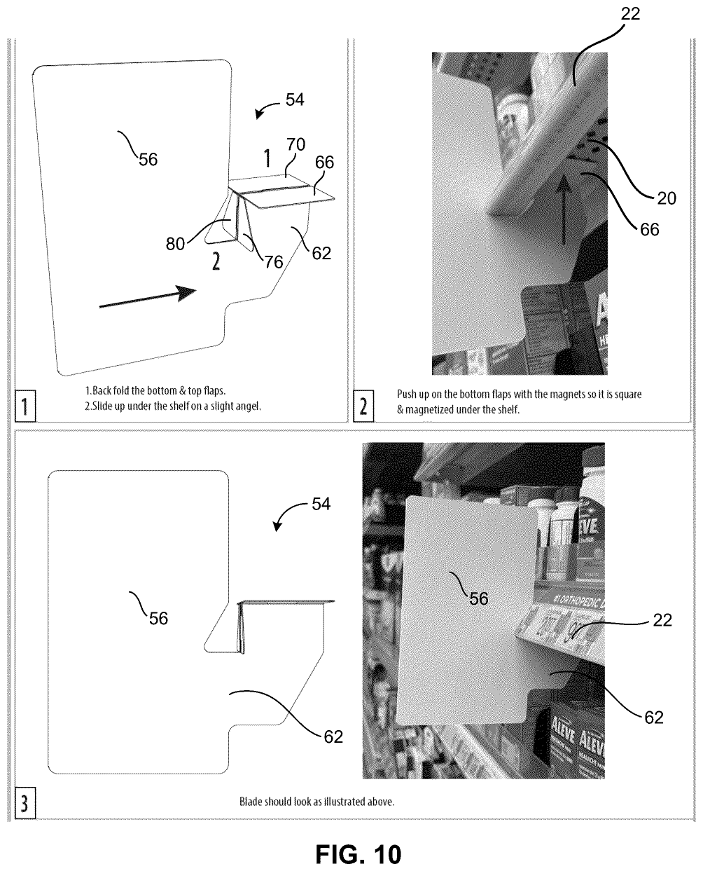

As evident in the steps of FIG. 10, the second graphic display panel 58 is rotated about the fold line 58 to abut the first graphic display panel 56. Similar to the slide in style, the second graphic display panel 58 mirrors the shape of the first graphic display panel 56. Each of the first magnetic flap 66 and second magnetic flap 70 are rotated about the top edges of the arm portions 62, 64 to a horizontal position, and the first stabilizing segment 78 and second stabilizing segment 80 are rotated vertically outward as shown on the left side of FIG. 10. The display 54 is then fitted around the C-channel 22 to position the magnetic flaps 66, 70 against a lower surface of the shelf 20—this will adhere the display 54 to the shelf 20. The opening above the arm portions 62, 64 defined when the stabilizing segment 76, 80 were rotated, is sized and shaped to accommodate and closely fit around the C-channel 22 when the display 54 is connected to the shelf 20.

While the display 54 is shown having a first and second graphic display panel 62, 64. A single graphic display panel can be used. The blank for the display 54 can also be formed from paperboard or other similar or suitable materials.

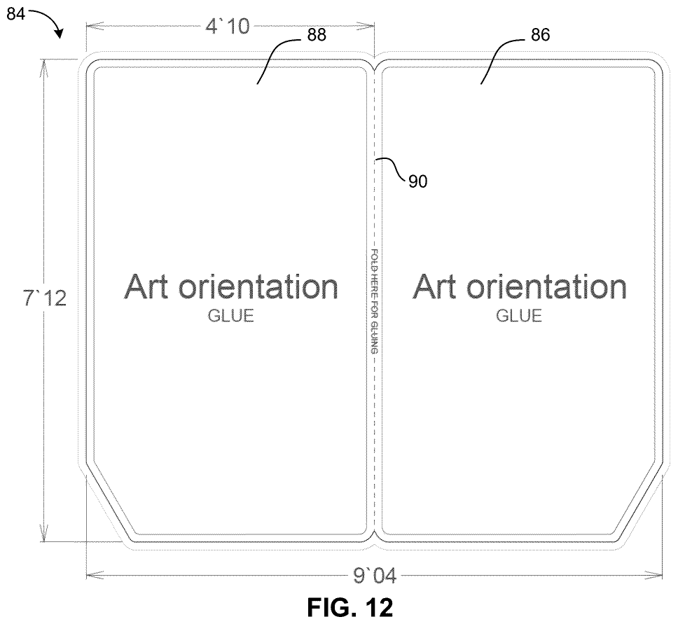

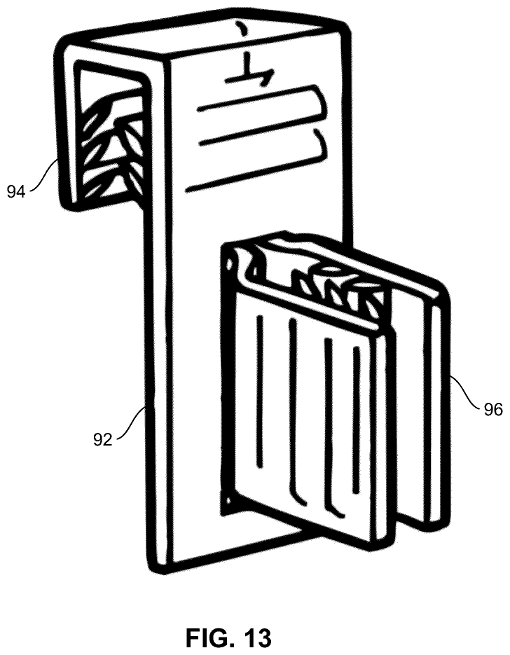

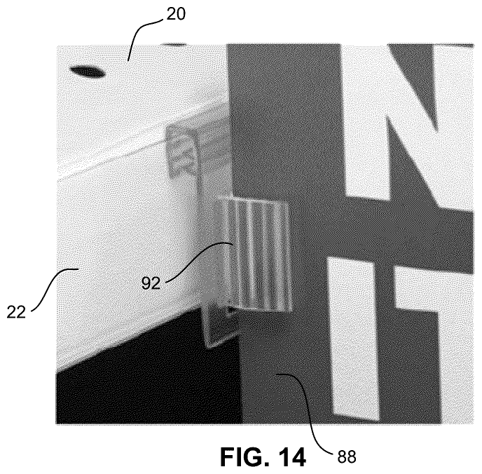

In accordance with another aspect of the invention, another sustainable display 84 is shown in FIGS. 12-14. The display 84 includes a first graphic display panel 86 rotate-ably connected to a second graphic display panel 88 by a fold line 90. The display 84 also includes a sign holder 92. The sign holder 92 includes a first clip section 94 for securing the sign holder 92 to the C-channel 22 of the shelf 20, and a second clip section 96 for securing the first and second graphic display panels 86, 90 to the sign holder 92. The graphic display panels 86, 88 can be formed from paperboard or other similar or suitable materials. The sign holder 92 can be formed from plastic or other similar or suitable materials. While the display 84 is shown having two graphic display panels 86, 88, a single panel can also be used.

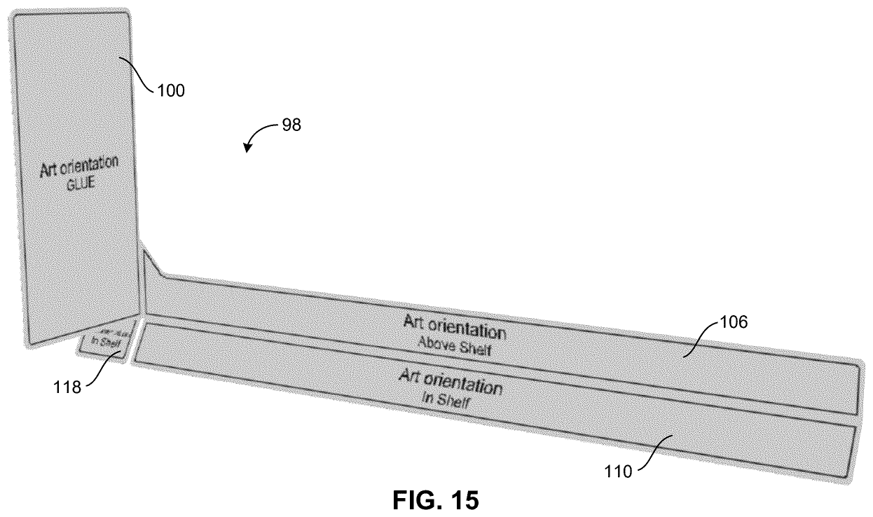

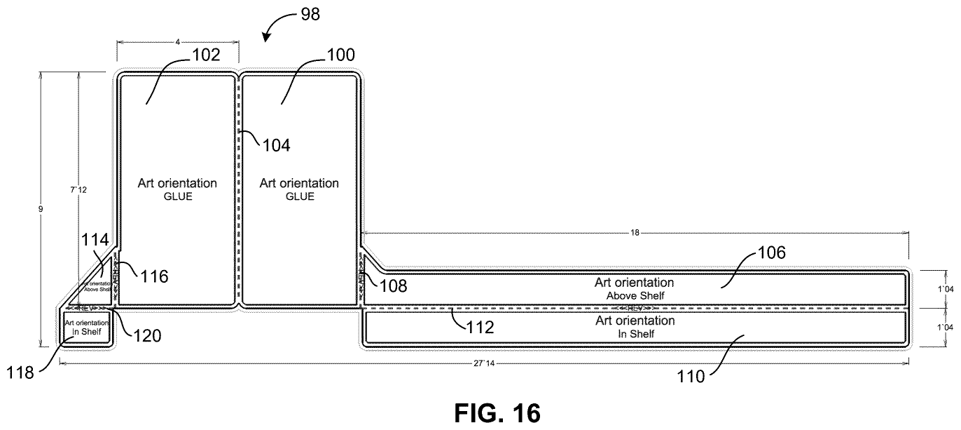

A display 98 in accordance with another aspect of the invention is shown in FIGS. 15 and 16. The display 98 includes a first graphic display panel 100 rotate-ably connected to a second graphic display panel 102 by a fold line 104. An elongated first positioning panel 106 extends outward from and is rotate-ably connected to a lower portion of a first side of the first graphic display panel 100 by a fold line 108. A first lower flap 110 is rotate-ably connected to a lower edge of the first positioning panel 106 by a fold line 112. A second positioning panel 114 is rotate-ably connected to a lower portion of a first side of the second graphic display panel 102 by a fold line 116. A second lower flap 118 is rotate-ably connected to a lower edge of the second positioning panel 114 by a fold line 120.

To connect the display 98 to a shelf, the second graphic display panel 102 is rotated to contact the first graphic display panel 100 about the fold line 104. The first lower flap 110 and the second lower flap 118 can then be inserted into the pocket of the C-channel 22 of a shelf 20. While the display 98 is shown having two graphic display panels 100, 102, a single panel can also be used (albeit, without the second positioning panel 114 and second lower flap 118). The display 98 can be formed from paperboard or other similar or suitable material.

Many modifications and variations of the present invention are possible in light of the above teachings. It is, therefore, to be understood within the scope of the appended claims the invention may be protected otherwise than as specifically described.

We claim:

1. A signage display for attaching to a retail store shelf comprising:
a first graphic display panel having a first arm portion extending outward on a first side of the first graphic display panel, the first arm potion configured to receive a C-channel extending from an edge of a shelf and extend under the C-channel;
a first positioning panel rotate-ably connected to the first graphic display panel on the first side and spaced above the arm portion; and,
a first flap extending below the first positioning panel for engaging the C-channel of the shelf to secure the first graphic display panel to the shelf.

2. The signage display of claim 1 wherein the first positioning panel is rotate-ably connected to the first graphic display panel by a fold line.

3. The signage display of claim 2 wherein the first flap is connected to the first positioning panel by a fold line.

4. The signage display of claim 1 further comprising a second graphic display panel connected to the first graphic display panel by a fold line along a second side of the first graphic display panel.

5. The signage display of claim 4 wherein the second graphic display panel has a second arm portion extending outward from a first side of the second graphic display portion.

6. The signage display of claim 5 further comprising a second flap rotate-ably connected to a top edge of the second arm portion.

7. The signage display of claim 6 wherein the second flap is rotate-ably connected to the top edge of the second arm by a fold line.

8. The signage display of claim 7 further comprising a side extension flap rotate-ably connected to a first side of the second flap.

9. The signage display of claim 8 wherein the side extension panel is rotate-ably connected to the second flap by a fold line.

10. The signage display of claim 4 further comprising a second positioning panel rotate-ably connected to and extending outward from a first side of the second graphic display portion.

11. The signage display of claim 1 wherein the first graphic display panel is formed from paperboard.

12. A signage display for attaching to a retail store shelf comprising:
a first graphic display panel having a first arm portion extending outward on a first side of the first graphic display panel, the first arm potion configured to receive a C-channel extending from an edge of a shelf and extend under the C-channel; and,
a first magnetic flap rotate-ably connected to a top edge of the first arm portion for contacting a lower surface of the shelf.

13. The signage display of claim 12 wherein a magnetic strip is connected to the first magnetic flap.

14. The signage display of claim 12 wherein the first magnetic flap is rotate-ably connected to the top edge of the first arm portion by a fold line.

15. The signage display of claim 12 further comprising a first stabilizing panel rotate-ably connected to an inner vertical edge of the first arm portion.

16. The signage display of claim 15 wherein the first stabilizing panel is rotate-ably connected to an inner vertical edge of the first arm portion by a fold line.

17. The signage display of claim 15 further comprising a second graphic display panel having a second arm portion extending outward on a first side of the second graphic display panel, the second graphic display panel connected to the first graphic display panel by a fold line.

18. The signage display of claim 17 further comprising a second magnetic flap rotate-ably connected to a top edge of the second arm portion by a fold line.

19. The signage display of claim 18 further comprising a second stabilizing panel rotate-ably connected to an inner vertical edge of the second arm portion by a fold line.

20. The signage display of claim 12 wherein the first graphic panel is formed from paperboard.
